(19) United States
(12) Patent Application Publication
(10) Pub. No.: US 2008/0123885 A1
(43) Pub. Date: May 29, 2008

(54) FEEDBACK COMPENSATION METHOD AND CIRCUIT FOR AN ACOUSTIC AMPLIFICATION SYSTEM, AND HEARING AID DEVICE EMPLOYING SAME

(76) Inventor: Tom Weidner, Erlangen (DE)

Correspondence Address: SCHIFF HARDIN, LLP;PATENT DEPARTMENT, 6600 SEARS TOWER, CHICAGO, IL, 60606-6473, US

(21) Appl. No.: 12/028,259

(22) Filed: Feb. 8, 2008

Related U.S. Application Data
(63) Continuation of application No. 10/659,230, filed on Sep. 10, 2003, now abandoned.

(30) Foreign Application Priority Data
Sep. 13, 2002 (DE) 10242700.3

(51) Int. Cl. H04R 25/00

(52) U.S. Cl. 381/318

(57) ABSTRACT

In a feedback compensation method and a feedback compensator in an acoustic amplification system such as a hearing aid, an adaptive feedback compensation filter generates a compensation signal from the amplified output signal, and one or more filters restrict the frequency range in which the compensation signal is generated. These filters are adaptable with regard to their filter function during the operation of the feedback compensator. The adaptation ensues with an analysis and control unit that checks the frequency range affected by the feedback and adapts the filter functions of the filters to it. The checking ensues, for example, by a comparison of the filter function of the feedback compensation filter with the filter functions of the filters to restrict the frequency range, or with the use of an oscillation detector.

### RELATED APPLICATION

The present application is a continuation of application Ser. No. 10/659,230, filed Sep. 10, 2003 (now abandoned).

### BACKGROUND OF THE INVENTION

1. Field of the Invention

The present invention concerns a method and a feedback compensator in an acoustic amplification system to compensate a feedback signal that occurs in a feedback path upon amplification of an input signal, of the type having an adaptive feedback compensation filter that generates a compensation signal based on the amplified output signal. The invention also applies to a hearing aid device with such a feedback compensator, and operable according to the method.

2. Description of the Prior Art

In hearing aid devices, a problem commonly exists of unwanted acoustic feedback between an auditory transducer and a microphone. The cause of feedback is the existence of a path between the amplified output and input that allows a component of the amplified input signal at a particular frequency to proceed back to the input, which is beyond the stability limit of the amplifier. In the context of hearing aid amplification, a feedback can cause whistling noises or other interferences and thereby significantly reduce the usefulness of the hearing aid device for the wearer, or even reduce it to zero. Depending on the characteristics of the hearing aid device and the auditory situation, feedback can ensue at different frequencies and in different frequency ranges.

With the use of an adaptive feedback compensator of the type initially described, a compensation signal is generated that is subtracted from the input signal before the amplification, such that the feedback component at the frequency causing the feedback is reduced to an intensity that lies below the stability limit.

The feedback compensation conventionally ensues using an adaptive feedback compensation filter that is known as an FIR filter (Finite Impulse Response filter). This generates the compensation signal by filtering the amplified output signal. The feedback compensation filter is adjusted with an adaptation unit that, for example using filter coefficients of the feedback compensation filter, tests the effect of the feedback compensation filter to be adjusted such that an error signal, generally the input signal directly before entry into the amplification system, is minimized to the smallest signal energy content. For such an optimization, the error signal and the output signal are compared by the adaptation unit by means of an LMS (least mean square) function. The adaptation of the coefficients cannot ensue too quickly or too slowly. The adaptation is characterized by the adaptation increments, i.e. the changes of the coefficients, and by the speed with which the new coefficients are transmitted to the feedback compensation filter.

Given use of feedback compensation filters, artifacts and/or unintentional distortion of the input signal can occur. Artifacts thus generated are perceivable by a hearing aid device user given the use of such feedback compensator in a hearing aid device.

Different feedback compensators are known, for example from WO 00/19605, which teaches the bandwidth of the compensation signal in order to minimize disruptions due to the feedback compensation filter, and limiting the unstable frequency range. The limitation of the frequency range has the disadvantage that it is implemented with a filter that sets the unstable frequency range according to the set or fixed characteristics of the filter. The frequency range of the feedback, however, can change during use, for example due to the pressure of a gap between an in-the-ear hearing aid device and the ear canal of the hearing aid device user, or due to changing external acoustic general conditions, such as wearing a helmet. This quickly leads to a limitation of the frequency range that is too wide, too narrow, or completely false, with a correspondingly deficient function of the feedback compensator, and the hearing aid device.

### SUMMARY OF THE INVENTION

An object of the present invention is to provide a feedback compensator, a hearing aid device with a feedback compensator, a method to compensate a feedback signal in an acoustic amplification system that enable an effective and rapid feedback compensation with high sound quality.

This object is achieved in a feedback compensator of the type initially described, wherein the frequency-limiting filter is adaptable with regard to its filter function during the operation of the feedback compensator. The filter function of any filter specifies its transfer function, i.e. the transmissivity of the filter at a predetermined frequency. The filter function also determines the frequency range in which the filter operates. “Adaptable with regard to its filter function” as used herein means that the filter function is variable based on the changing feedback situation. The adaptation capability of the frequency-limiting filter provides the advantage that this filter can be automatically adapted to the currently existing unstable frequency range. The operation of the feedback compensator with regard to the frequency range also can be automatically optimized, such that the feedback compensation can be implemented very effectively and quickly with minimal artifacts in the amplified output signal.

A further advantage is that the feedback compensator can have a learning capability in regard to the filter function, due to the adaptation process. This allows it to initially set the frequency-limiting filter to a basic setting based on experience or measurement. If, during the use of the feedback compensation filter, it encounters feedback in another frequency not covered by the basic setting, the filter function can be expanded to this frequency range. Such a learning-capable system, for example, can also implement tests that check whether the frequency range recognized by the filter function has been adjusted to be too wide. If so, the frequency range can be correspondingly reduced. This achieves an accelerated feedback compensation with fewer artifacts.

In an embodiment of the feedback compensator, the frequency-limiting filter is formed by a number of individual filters. These together provide the filter function of the frequency-limiting filter. The advantage of such a modular filter assembly is that it offers multiple possibilities for adjusting the filter function. A simple realization of the adaptability of the frequency range of the frequency-limiting filter is possibly by switching between two or more individual filters to adapt to the frequency range of the currently existing feedback.

In another embodiment of the feedback compensator, the filter function of the frequency-limiting filter is variable by means of an adjustable coefficients. This has the advantage that all necessary filter functions can be realized with a single adjustable filter.

In a further embodiment of the feedback compensator, the amplified output signal is connected with the feedback compensation filter via the frequency-limiting filter. This has the advantage that the frequency-limiting filter primarily affects the feedback compensation path.

In a further embodiment, the feedback compensator has a control unit to adapt the frequency-limiting filter. Such a control unit can be, for example, a changeover switch to select an individual filter or combination of individual filters (if the frequency-limiting filter is composed of a number of individual filters), or it can adjust filter coefficients of the frequency-limiting filter.

In another embodiment, the feedback compensator has an analysis unit to check the feedback compensator. Such an analysis unit, for example, can check one or more parameters of the adaptive feedback compensation filter and make a comparison with one or more filter parameters of the frequency-limiting filter. It can, for example, be deduced from a good concordance of the filter parameters that the frequency-limiting filter is properly adapted to the feedback compensation filter. A poor concordance of the filter parameters can indicate the necessity of a further adaptation step to adapt the filter function of the frequency-limiting filter.

In a further embodiment, the analysis unit has a comparator to compare the input signal with the filtered output signal. From such a comparison it can be determined whether and in which frequency range feedback is present. The frequency range of the frequency-limiting filter then can be adapted.

In a further embodiment of the feedback compensator, the analysis unit has an oscillation detector that is used to measure feedback in the amplified frequency range. Advantages of such an oscillation detector are that a continual monitoring with regard to feedback is possible, and that, in the event that feedback ensues, information about the frequency range of the feedback is also immediately available. A further advantage is that in many hearing aid devices, such oscillation detectors are already implemented.

In another embodiment in the hearing aid context, feedbacks that ensue over an acoustic feedback path are suppressed with the feedback compensator. As used herein “acoustic feedback path” encompasses both the transmission of the feedback via structure-borne sound and via airborne sound. The structure-borne sound can be prevented, for example, by suitable reinforcements of the hearing aid device housing, i.e. by structural measures. In contrast, airborne sound is generally more difficult to control. Airborne sound is dependent on the adaptation of an in-the-ear hearing aid device to the anatomical conditions and it can change, for example, due to deformations of the anatomy given chewing or yawning, or due to changes in the acoustic surrounding. An exception is airborne noise that, for example, leads to feedback along the aeration holes. Since this feedback does not change, it can, for example, already be considered in the signal processing.

In another embodiment in the hearing aid context, the feedback compensator provides compensation for an electromagnetic feedback path. As used herein “electromagnetic feedback path” means, for example, the feedback of the speaker coil to the telecoil due to electromagnetic fields that are emitted in the operation of the speaker that are received by (coupled to) the telecoil. The advantage of the feedback compensator according to the invention lies in its flexibility with regard to the possible feedback paths.

In another embodiment of the feedback compensator, the adaptive feedback compensation filter has an adaptation unit that, for example, minimizes the error signal energy content associated with the input signal, acting as an error signal. In order to restrict this association to the frequency range relevant to the feedback, the adaptation unit is connected to the input in series a second frequency-limiting filter. This has the advantage that the feedback compensation filter is operated only in the frequency range that is affected by feedback, and that thus no artifacts are generated in the amplified output signal in the frequency range not affected by feedback.

In another embodiment of the feedback compensator, the adaptation unit is connected with the output of the initially described frequency-limiting filter via another frequency-limiting filter (third filter). This has the advantage that the adaptation unit and the feedback compensation filter can be operated with different filtered signals.

The filter function of this third filter is substantially the same as the filter function of the second filter. This has the advantage that both signals that are required by the adaptation unit to adapt the feedback compensation filter pass through substantially equivalent filter. This is a condition for a successful adaptation.

In a preferred embodiment of the feedback compensator, in addition to the first filter, the second and/or the third filter are also adaptable filters with regard to their respective filter functions. These adaptable filters also can be adapted with a control unit, for example the same as is used for the first filter. The adaptation for example, again can ensue by switching between different filters or by adjusting the filter coefficients of the second and/or third filter. A system in which all three filters are adaptable has the advantage of the greatest possible freedom via the filter functions that are required for a high-quality feedback compensation. The cooperation of filters that can be changed with regard to their filter function, control unit, and analysis unit always ensures the optimal use of the filter limiting bandwidth, such that the optimal function of the adaptation unit is ensured.

The object with regard to a hearing aid device is achieved by a hearing aid device that has a feedback compensator of the type specified above. The invention can be applied in all known hearing aid device types, for example in hearing aid devices worn behind the ear, hearing aid devices worn in the ear, implantable hearing aid devices, hearing aid device systems, or pocket hearing aid devices. The advantage of the learning capability of the feedback compensator applies as well to the hearing aid device. The frequency range in the delivery status of the device thus can be particularly narrowly selected in its presetting, in order to ensure the best possible sound. If feedback problems ensue, the device then adapts itself to the new acoustic relationships. A simplified variant in order to use the adaptivity of the frequency-limiting filter is to manually or automatically adapt the frequency range using an in-situ measurement of the feedback path.

Furthermore, the object is achieved in a method compensating a feedback signal in an acoustic system, wherein the feedback signal, given an amplification of an input signal, acts on the input signal from the amplified output signal due to a feedback path. The method includes the steps of using an adaptive feedback compensation filter to balance the feedback path by generating a compensation signal from the amplified output signal, and adapting the frequency range in which the compensation signal is generated is during the compensation.

In a particular embodiment of the method, to adapt the frequency range switching is made between a number of parallel filters or filter sets. The frequency range of the compensation signal is then determined by the filters or filter sets.

In an embodiment of the method, the frequency range adaptation is implemented with a frequency-limiting filter that is variable with regard to its filter function. The filter function can be changed, for example, by changing the coefficients. This enables adjustment of the frequency range with a single filter.

In an embodiment of the method, the feedback compensation is continuously checked by means of signal analysis.

In a further embodiment, parameters of the adaptive feedback compensation filter are compared by means of a signal analysis with the frequency range in which the feedback compensation ensues. Important information is thereby acquired as to whether the frequency range of the feedback signal coincides with the frequency range that is required by the feedback compensation filter, or whether an adaptation of the frequency range is necessary.

In another embodiment of the method, the input signal is checked for the presence of feedback signal components by means of a signal analysis. For this, for example, the input signal is examined for oscillations that give an indication of feedback having occurred.

In a further embodiment, an error signal filtered with a second frequency-limiting filter is compared with the signal for compensating the feedback during the adaptation. The signal for compensating the feedback before the comparison can be filtered with a third frequency-limiting filter. In order achieve ideal output conditions for a successful adaptation, the respective filter functions of the second and/or third filter also are adapted. For example, the filter function of the second and/or third filter can be selected by means of a changeover switch from a selection of individual filters. Alternatively, to adapt the second and/or third filter, their filter functions can be adjusted by means of filter coefficients.

In a preferred embodiment, all three filters are controlled by the same control unit and adapted with regard to their frequency range.

The important aspect of the invention thus is the control of the filter or filters that effect the frequency selection for the actual feedback compensation filter. If the frequency range is changed, the adaptation speed also can be simultaneously changed in order, for example, to effect a faster adaptation to a new frequency range. This can ensue in various ways. For example, the coefficients of the feedback compensation filter can be determined by continuous evaluation as in which frequency range creates the greatest feedback risk at the moment. If it is detected that increased feedback is occurring given the range of the present limit frequency, the feedback compensation filter can provide an expanded frequency range by being changed to other filter behavior, other coefficients, or another filter. Another possibility is offered given the presence of an oscillation detector, which can monitor the frequency ranges outside of the feedback compensation range. If this oscillation detector detects an oscillation at the boundaries or outside of the present frequency range processed by the feedback compensator, the frequency range of the compensation signal can once again be adapted.

In a hearing aid device with a feedback compensator that enables an adaptive frequency range selection according to the invention, adapted frequency range settings that are changed according to the situation are stored. This storage can ensue permanently or only temporarily, and gives the hearing aid device a memory of its parameters in determined situations. The stored frequency range settings can be selected for adaptation as a possible basic setting, given need for the adaptation to new feedback conditions. This makes the hearing aid device quasi-learning-capable, and allows it to adapt itself to the individual feedback conditions of the hearing aid device user.

This learning capability allows, for example, the selection of a restricted frequency range in the delivery status of the hearing aid device. This minimizes the possible artifacts and enables a good sound, even given tonal input signals. If the hearing aid device user has no feedback problems, or experiences such problems only in the very restricted frequency range of the basic setting, everything remains unchanged. If, however, feedback ensues one time at another location, the frequency range covered by the feedback compensation filter expands or shifts and compensates the feedback. The hearing aid device stores this change of the frequency range and uses the new basic frequencies as new presettings.

### DESCRIPTION OF THE DRAWINGS

FIG. 1 IS a schematic block diagram of a feedback compensator in accordance with the invention that adjusts, with an analysis and control unit, the coefficients of the filter that are necessary for feedback compensation.

FIG. 2 is am illustration for explaining the operation of the adaptation of the filter function by means of coefficients in accordance with the invention.

FIG. 3 is a schematic block diagram of a feedback compensator in accordance with the invention similar to the feedback compensator in FIG. 1, in which, to adapt the frequency range, an analysis and control unit controls a changeover switch to select different filters.

FIG. 4 Illustrates the transmission ranges of a filter set, from which exactly one filter is selected in accordance with the invention.

FIG. 5 illustrates the transmission ranges of a filter set with narrowband transmission ranges in accordance with the invention.

FIG. 6 is a schematic block diagram of a feedback compensator in accordance with the invention similar to the feedback compensator in FIG. 1, in which the analysis and control unit additionally has an oscillation detector that detects feedback signal portions in the input signal.

FIG. 7 is a schematic block diagram of a feedback compensator in accordance with the invention similar to the feedback compensators in the FIGS. 3 and 6 that has both a changeover switch and an oscillation detector.

### DESCRIPTION OF THE PREFERRED EMBODIMENTS

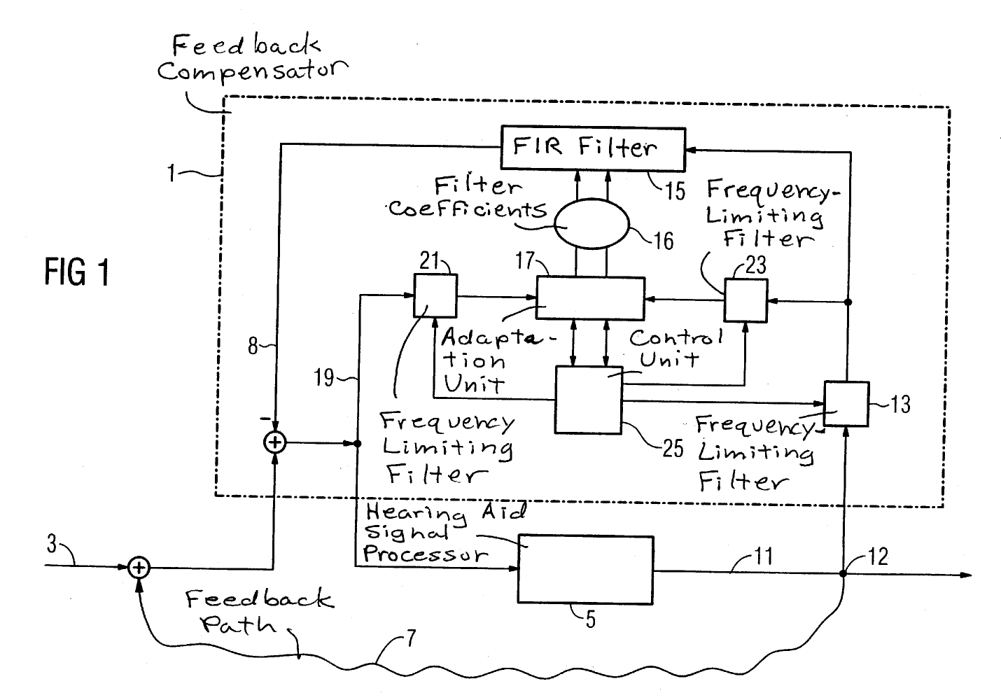

FIG. 1 is a schematic overview of a feedback compensator 1 that also enables a qualitatively good amplification of an acoustic input signal 3 with a hearing aid device signal processor 5, in the event that a feedback path is present, the frequency range of which can change due to varying external conditions. The feedback path 7 is, for example, determined by the diameter and by the position of the ventilation aeration holes of an in-the-ear hearing aid device as well as by an imperfect termination of the in-the-ear hearing aid device with the ear. Changes of the feedback path 7 also ensue when the acoustic surroundings change, for example when a helmet is put on or taken off.

The feedback compensator 1 is able to adapt the frequency range of the compensation signal 8 to the changing frequency range of the feedback path 7. For this, the feedback compensator 1 generates the compensation signal 8 in the following way. A small part of the output signal 11 of the hearing aid device signal processor 5 is tapped at a node 12 for the feedback compensator 1. There, it is restricted with a filter 13 with regard to the frequency range, and supplied to an FIR filter 15. The FIR filter 15 generates the compensation signal 8, by means of its filter function, from the signal filtered by the filter 13. For feedback compensation, the compensation signal 8 is subtracted from the input signal 3, before it is supplied to the hearing aid device signal processor 5.

The setting of the filter function of the FIR filter 15 ensues by means of filter coefficients 16 that are transmitted from an adaptation unit 17 to the FIR filter 15. For adaptation, the adaptation unit 17 compares an error signal 19, tapped from the input signal 3 after combining with the compensation signal 8, to the output signal 11 filtered with the filter 13. Both signals are restricted with regard to their frequency range with respective filters 21 and 23. By changing the coefficients 16 of the FIR filter 15, the adaptation unit 17 strives to prevent the feedbacks. As a control factor, for example, the signal energy of the error signal 19 normalized to the output signal 11 filtered with the filter 13 can be used. The coefficients 16 of the FIR filter 15 are changed such that the signal energy of the error signal 19 is minimal, i.e. free of feedback.

It is of significant importance for the adaptation of the frequency range of the compensation signal 8 to the changing frequency range of the feedback path 7 that the filters 13, 21, and 23 are adaptable in regards to their filter function. The adaptation ensues by the filter coefficients of the filter being adjusted by an analysis and control unit 25. The analysis and control unit 25 is connected with the adaptation unit 17 to exchange information about, for example, the filter coefficients 16 of the FIR filter. A comparison of the coefficients 16 with the coefficients or filter functions of the three filters 13, 21, and 23 enables the analysis and control unit 25 to re-adjust the three filters 13, 21, 23 with regard to their filter function, such that they overlay with the filter function of the FIR filter 15. The analysis and control unit 25 then informs the adaptation unit 17 about the adaptation increment and adaptation speed that best matches the frequency ranges adjusted by the three filters 13, 21, and 23.

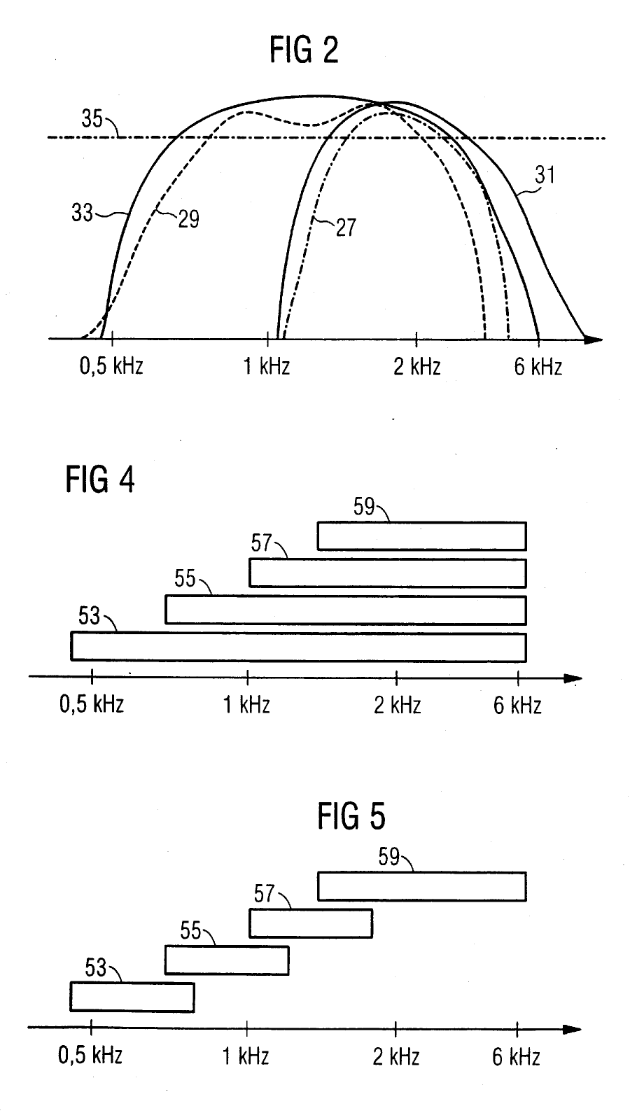

FIG. 2 shows the curves for certain coefficients explaining procedure for the adaptation of the filter function of, for example, the filter 13. The amplitude of the feedback path 7 is shown dependent on the frequency, for the case of feedback in a narrow frequency range (feedback amplitude 27), and for the case of a change in the acoustic surrounding that leads to a feedback risk in a large frequency range (feedback amplitude 29). For both cases, the transmission of the filter 13 is additionally plotted. The transmission curve 31 for the first case is centered around 2 kHz. The transmission drops off to lower frequencies corresponding to the feedback amplitude, such that only signal energy above 1 kHz is transferred for feedback compensation to the FIR filter 15. In the second case, due to the changes in the acoustic surrounding, feedbacks are also possible in the frequency range from 0.5 kHz to 1 kHz. The analysis and control unit 25 of the feedback compensator 1 thereupon adjusts a new filter function for the filter 13 (transmission curve 33) that lets pass to the FIR filter 15 a significantly increased frequency range of approximately 0.5 kHz to 2.5 kHz. To assess the feedback risk, the stability limit is additionally shown in FIG. 2.

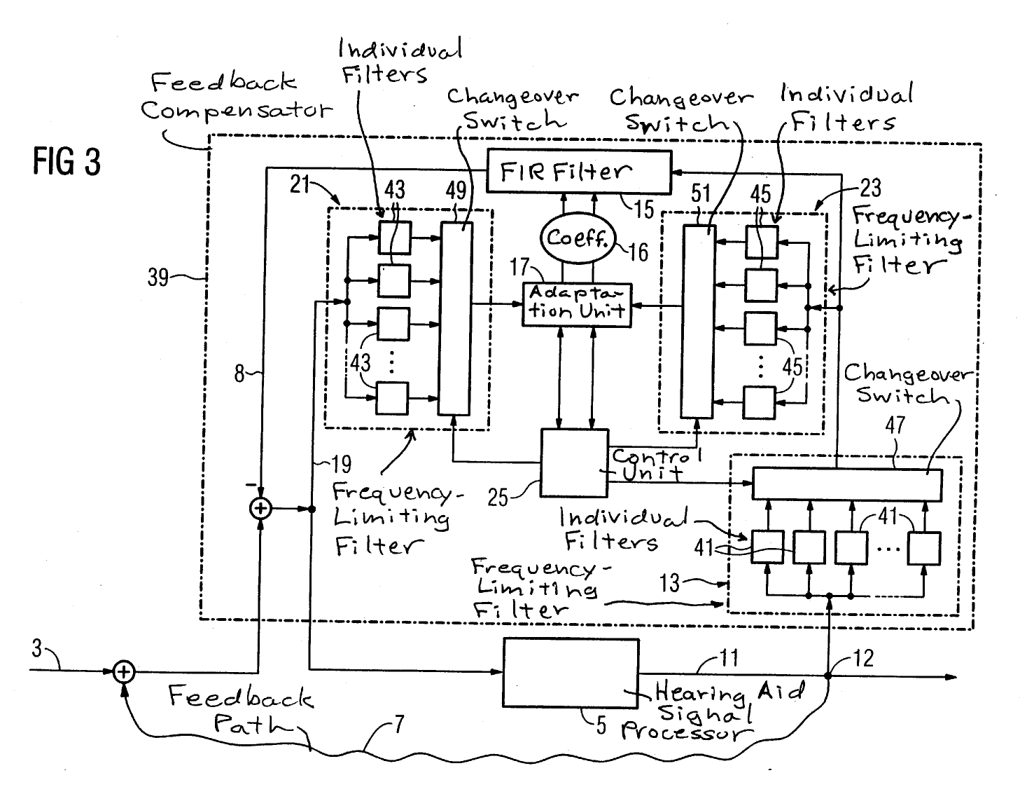

FIG. 3 is a schematic block diagram of a feedback compensator 39 that substantially coincides with regard to assembly and functionality with the feedback compensator 1 in FIG. 1. The important difference is in the realization of the filters 13, 21, and 23 and in the adaptation of their filter functions to limit the frequency range of the feedback compensation.

The filters 13, 21, and 23 are respectively formed by filter sets 41, 43, and 45 and changeover switches 47, 49, and 51. The filters of the filter sets 41, 43, and 45 cover the frequency range relevant for the feedback. The adaptation of the filter functions ensues via switches between the different filters of the filter sets 41, 43, 45 to be switched or via the combined use of a selection of filters in order to add their functions. The changeover switches 47, 49, 51 are controlled by the analysis and control unit 25. The analysis and control unit 25 in addition compares, as in FIG. 1 the different filter functions with the coefficients of the three filters 13, 21, and 23 and adapts the filter functions of the three filters 13, 21, 23 as best possible to the filter function of the FIR filter 15. In contrast to the feedback compensator 1, the feedback compensator 39 has the advantage that the realization of the filters 13, 21, and 23 with use of the changeover switches 47, 49, and 51 and the fixed preset filters of the filter sets 41, 43, and 45 is simpler, space saving, and energy saving. It has the disadvantage, however, that the filter functions in terms of their gradient can not be as adapted as precisely as can be accomplished with the feedback compensator 1 of FIG. 1.

An exemplary segmentation of the frequency range relevant to feedback between 0.5 kHz and 6 kHz on the filter of a filter set, for example, the four filters 53, 55, 57, and 59 of the filter set 41, is shown in FIG. 4. The transmission ranges of the filters 53, 55, 57, and 59 extend starting from different lower limit frequencies to the common upper limit of 6 kHz. To suppress the feedback amplitude 27, the use of the filter 57 is sufficient. Given a change in the feedback amplitude 29 with a feedback risk in a broader frequency range, the analysis and control unit 25 recognizes this expansion and controls the changeover switch 47 such that the filter 53 is used for frequency limiting.

FIG. 5 shows an alternative segmentation of the frequency range with the filters 53, 55, 57, and 59 that are in this case narrowband filters. The transmission ranges of the filters 53, 55, 57, and 59 mutually cover the frequency range relevant for the feedback. The transmission ranges overlap in the edge zones. The feedback amplitude 27 is sufficiently compensated via the use of the filters 53 and 55, while all four filters 53, 55, 57, and 59 are simultaneously used by the changeover switch 47 for the feedback amplitude 29.

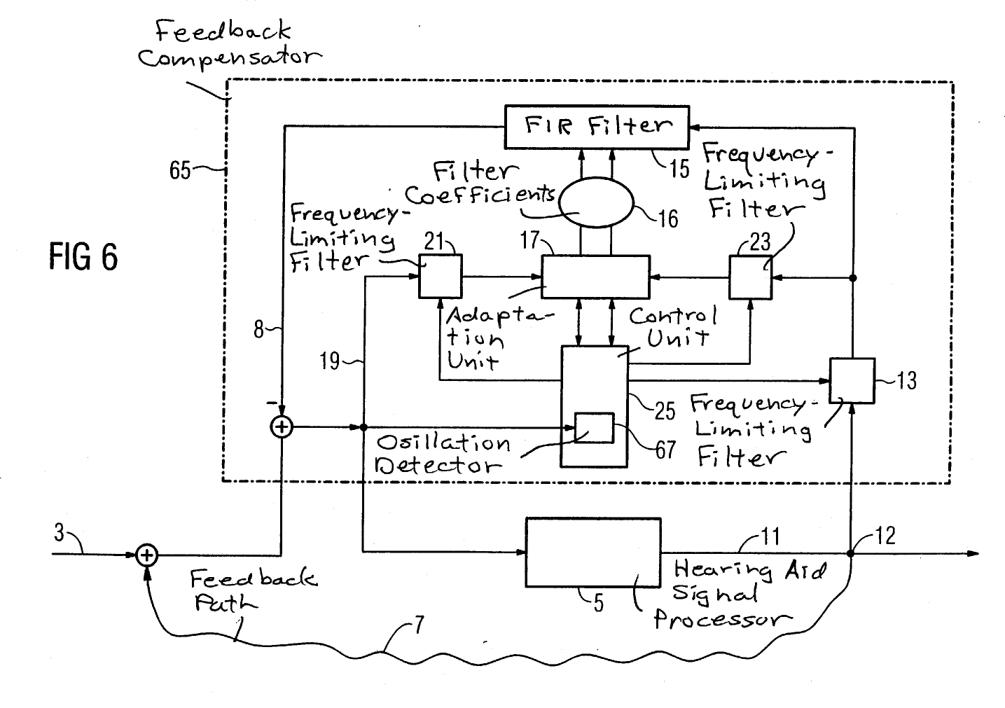

A feedback compensator 1 is shown in FIG. 6, the functionality and operation of which again substantially correspond to that of the feedback compensators 1 and 39 in the FIGS. 1 and 3. The analysis and control unit 25 additionally has an oscillation detector 67 that is connected with the input signal after the infeed of the compensation signal 8. The oscillation detector 67 examines the input signal 3 for oscillations that dominate the input signal 3 and give an indication of a feedback risk outside of the covered frequency range. If the analysis and control unit 25 recognizes a new feedback frequency with the aid of the oscillation detector 67, the filter function of the filters 13, 21, and 23 is expanded to this new frequency range. The advantage of this exemplary embodiment is that for the most part an oscillation detector that is already present in the hearing aid device can be used for this purpose. This simplifies the realization of the feedback compensator 65.

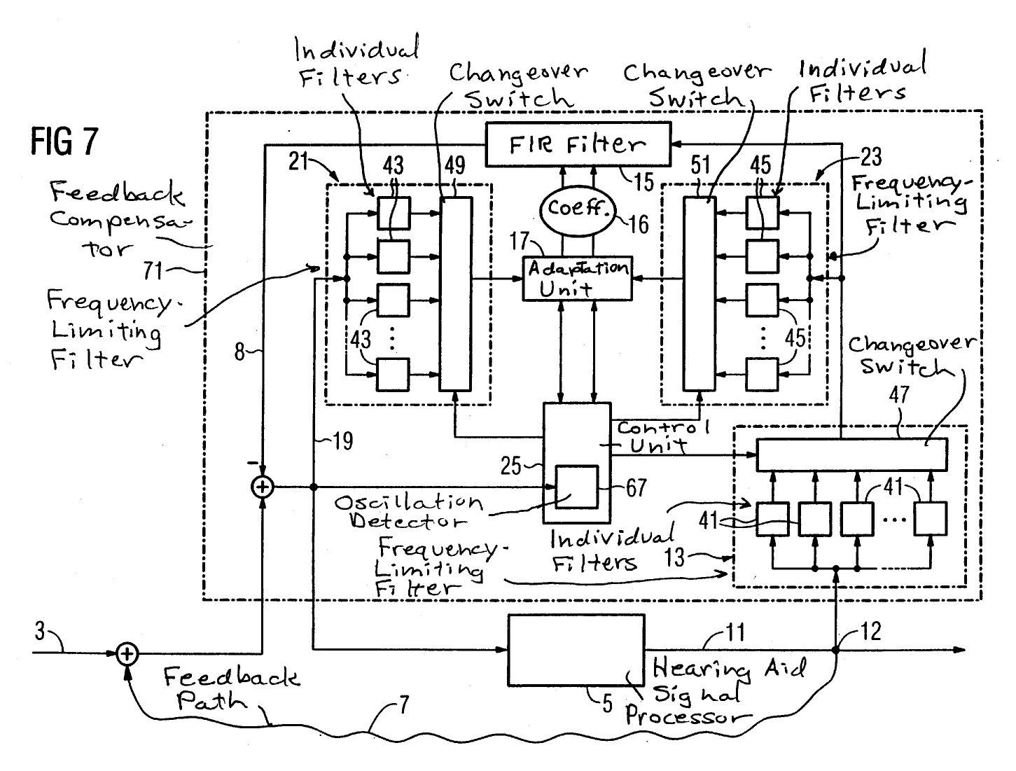

A schematic diagram of a further exemplary embodiment for a feedback compensator is shown in FIG. 7. The feedback compensator 71 arises substantially from the combination of the feedback compensator 39 from FIG. 3 and 65 from FIG. 6. This particular advantageous embodiment combines the simply realized changeover switch device between different filters and the use of an oscillation detector that is generally already present to analyze feedback. The quality and speed of the adaptation process to adjust the filter function of the FIR filter 15 can also be increased here, by the frequency range adaptation of the filters 13, 21, and 23.

Although modifications and changes may be suggested by those skilled in the art, it is the intention of the inventor to embody within the patent warranted hereon all changes and modifications as reasonably and properly come within the scope of his contribution to the art.

We claim as our invention:

1. A feedback compensator for use in an acoustic amplification system to compensate feedback that acts on an input signal, upon amplification of said input signal, due to a feedback path from an amplified output signal, said feedback compensator comprising:
an adaptive feedback compensation filter that generates a compensation signal, from said amplified output signal, for compensating said feedback, said compensation signal being combined with said input signal; and
a frequency-limiting filter connected relative to said adaptive feedback compensation filter to limit a frequency range within which said adaptive feedback compensation filter compensates said feedback, said frequency-limiting filter having a filter function that is adaptable during compensation of said feedback by said adaptive feedback compensation filter.

2. A feedback compensator as claimed in claim 1 wherein said frequency-limiting filter is comprised of a plurality of individual filters, having respective filter functions that, in combination, form said filter function of said frequency-limiting filter.

3. A feedback compensator as claimed in claim 2 wherein said individual filters have respectively different filter functions, and wherein at least one of said individual filters is selectable to adapt said filter function of said frequency-limiting filter.

4. A feedback compensator as claimed in claim 2 wherein said feedback may occur within a frequency range, and wherein the respective filter functions of said individual filters, in combination, cover said frequency range.

5. A feedback compensator as claimed in claim 1 wherein said frequency-limiting filter has filter coefficients associated therewith, and wherein said filter function of said frequency-limiting filter is adapted by modification of said coefficients.

6. A feedback compensator as claimed in claim 1 wherein said amplified output signal is supplied to the adaptive feedback compensation filter through said frequency-limiting filter.

7. A feedback compensator as claimed in claim 1 further comprising a control unit connected to said frequency-limiting filter for adapting said filter function of said frequency-limiting filter.

8. A feedback compensator as claimed in claim 7 wherein said frequency-limiting filter is comprised of a plurality of individual filters having respectively different filter functions that in combination form said filter function of said frequency-limiting filter, and further comprising a changeover switch operated by said control unit to select at least one of said individual filters for adapting said filter function of said frequency-limiting filter.

9. A feedback compensator as claimed in claim 7 wherein said frequency-limiting filter has filter coefficients, and wherein said control unit adjusts at least one of said filter coefficients to adapt said filter function of said frequency-limiting filter.

10. A feedback compensator as claimed in claim 1 wherein said compensation signal is combined with said input signal to produce a feedback-compensated input signal, and wherein said feedback compensator further comprises an analysis unit connected to analyze said feedback-compensated input signal to determine an effectiveness of said feedback compensation.

11. A feedback compensator as claimed in claim 10 wherein said analysis unit determines said effectiveness of said feedback compensation by checking a parameter of said adaptive feedback compensation filter.

12. A feedback compensator as claimed in claim 10 wherein said analysis unit determines the effectiveness of said feedback compensation by comparing said feedback-compensated input signal to said output signal with regard to feedback content.

13. A feedback compensator as claimed in claim 10 wherein said analysis unit is an oscillation detector which measures said feedback in a frequency range.

14. A feedback compensator as claimed in claim 1 wherein said input signal is subject to feedback via an acoustic feedback path.

15. A feedback compensator as claimed in claim 1 wherein said input signal is subject to feedback via an electromagnetic feedback path.

16. A feedback compensator as claimed in claim 1 comprising an adaptation unit, connected to said adaptive feedback compensation filter, for modifying operation of said adaptive feedback compensation filter dependent on evaluation of a signal within said acoustic amplification system.

17. A feedback compensator as claimed in claim 16 wherein said adaptation unit is connected to receive said input signal for error signal evaluation thereof.

18. A feedback compensator as claimed in claim 17 wherein said input signal is supplied to said adaptation unit through a further frequency-limiting filter.

19. A feedback compensator as claimed in claim 18 wherein said further frequency-limiting filter has a filter function that is adaptable during compensation of said feedback by said adaptive feedback compensation filter.

20. A feedback compensator as claimed in claim 19 further comprising a control unit connected to said frequency-limiting filter and said further frequency-limiting filter to adapt the respective filter functions of said frequency-limiting filter and said further frequency-limiting filter.

21. A feedback compensator as claimed in claim 20 wherein said further feedback-limiting filter is comprised of a plurality of individual filters having respectively different filter functions that in combination form the filter function of said further frequency-limiting filter, and wherein said feedback compensator further comprises a changeover switch operated by said control unit to select at least one of said individual filters to adapt said filter function of said further frequency-limiting filter.

22. A feedback compensator as claimed in claim 20 wherein said further frequency-limiting filter has filter coefficients, and wherein said control unit adjusts at least one of said filter coefficients to adapt said filter function of said further frequency-limiting filter.

23. A feedback compensator as claimed in claim 16 wherein said adaptation unit is connected to receive an output of said frequency-limiting filter.

24. A feedback compensator as claimed in claim 23 further comprising a further feedback-limiting filter through which said output of said frequency-limiting filter is supplied to said adaptation unit.

25. A feedback compensator as claimed in claim 24 wherein said further frequency-limiting filter has a filter function that is adaptable during generation of said compensation of said feedback by said adaptive feedback compensation filter.

26. A feedback compensator as claimed in claim 25 further comprising a control unit connected to said frequency-limiting filter and said further frequency-limiting filter to adapt the respective filter functions of said frequency-limiting filter and said further frequency-limiting filter.

27. A feedback compensator as claimed in claim 26 wherein said further feedback-limiting filter is comprised of a plurality of individual filters having respectively different filter functions that in combination form the filter function of said further frequency-limiting filter, and wherein said feedback compensator further comprises a changeover switch operated by said control unit to select at least one of said individual filters to adapt said filter function of said further frequency-limiting filter.

28. A feedback compensator as claimed in claim 26 wherein said further frequency-limiting filter has filter coefficients, and wherein said control unit adjusts at least one of said filter coefficients to adapt said filter function of said further frequency-limiting filter.

29. A feedback compensator as claimed in claim 16 wherein said frequency-limiting filter is a first frequency-limiting filter, and wherein said adaptation unit is connected to receive said input signal and to receive an output from said first frequency-limiting filter, and wherein said feedback compensator further comprises a second frequency-limiting filter through which said input signal is supplied to said adaptation unit, and a third frequency-limiting filter through which said output from said first frequency-limiting filter is supplied to said adaptation unit.

30. A feedback compensator as claimed in claim 29 wherein said second frequency-limiting filter has a filter function that is substantially identical to a filter function of said third frequency-limiting filter.

31. A feedback compensator as claimed in claim 29 wherein each of said second and third frequency-limiting filters has a filter function that is adaptable during compensation signal of said feedback by said adaptive feedback compensation filter.

32. A feedback compensator as claimed in claim 31 further comprising a control unit connected to said first, second and third frequency-limiting filters for adapting the respective filter functions of said first, second and third frequency-limiting filters.

33. A feedback compensator as claimed in claim 32 wherein each of said second and third frequency-limiting filters is comprised of a plurality of individual filters having respectively different filter functions that in combination form the respective filter functions of said first, second and third frequency-limiting filters, and wherein said frequency compensator further comprises a first changeover switch operable by said control unit to select at least one of said individual filters of said second frequency-limiting filter to adapt the filter function of said second frequency-limiting filter, and a second changeover switch operable by said control unit to select at least one of the individual filters of said third frequency-limiting filter to adapt the filter function of the third frequency-limiting filter.

34. A feedback compensator as claimed in claim 32 wherein each of said second and third frequency-limiting filters has filter coefficients, and wherein said control unit adjusts at least one of the filter coefficients of said second frequency-limiting filter to adapt the filter function of the second frequency-limiting filter, and adjusts at least one of the filter coefficients of the third frequency-limiting filter to adapt the filter function of the third frequency-limiting filter.

35. A hearing aid comprising:
an input transducer that produces an input signal from an incoming acoustic signal;
a hearing aid signal processor supplied with said input signal that amplifies said input signal to produce an amplified output signal, said input signal being influenced by feedback, via a feedback path, upon amplification thereof;
an adaptive feedback compensation filter that generates a compensation signal, from said amplified output signal, for compensating said feedback, said compensation signal being combined with said input signal; and
a frequency-limiting filter connected relative to said adaptive feedback compensation filter that limits a frequency range within which said adaptive feedback compensation filter compensates said feedback, said frequency-limiting filter having a filter function that is adaptable during compensation of said feedback by said adaptive feedback compensation filter.

36. A method for compensating feedback in an acoustic amplification system, said feedback acting on an input signal, upon amplification of said input signal, due to a feedback path from an amplified output signal, said method comprising the steps of:
generating a compensation signal in an adaptive feedback compensation filter from said amplified output signal, for compensating said feedback, and combining said compensation signal with said input signal; and
limiting a frequency range within which said adaptive feedback compensation filter compensates said feedback with a frequency-limiting filter connected relative to said adaptive feedback compensation, and adapting a filter function of said frequency-limiting filter during compensation of said feedback by said adaptive feedback compensation filter.

37. A method as claimed in claim 36 comprising forming said frequency-limiting filter of a plurality of individual filters, having respective filter functions that, in combination, form said filter function of said frequency-limiting filter.

38. A method as claimed in claim 37 wherein said individual filters have respectively different filter functions, and selecting at least one of said individual filters to adapt said filter function of said frequency-limiting filter.

39. A method as claimed in claim 37 wherein said feedback may occur within a frequency range, and covering said frequency range with respective filter functions of said individual filters, in combination.

40. A method as claimed in claim 36 wherein said frequency-limiting filter has filter coefficients associated therewith, and comprising adapting said filter function of said frequency-limiting filter modification of said coefficients.

41. A method as claimed in claim 36 comprising supplying said amplified output signal to the adaptive feedback compensation filter through said frequency-limiting filter.

42. A method as claimed in claim 36 further comprising adapting said filter function of said frequency-limiting filter with a control unit connected to said frequency-limiting filter.

43. A method as claimed in claim 42 comprising forming said frequency-limiting filter of a plurality of individual filters having respectively different filter functions that in combination form said filter function of said frequency-limiting filter, and comprising operating a changeover switch operated with said control unit to select at least one of said individual filters for adapting said filter function of said frequency-limiting filter.

44. A method as claimed in claim 42 wherein said frequency-limiting filter has filter coefficients, and comprising adjusting at least one of said filter coefficients with said control unit to adapt said filter function of said frequency-limiting filter.

45. A method as claimed in claim 36 comprising combining said compensation signal with said input signal to produce a feedback-compensated input signal, and analyzing said feedback-compensated input signal to determine an effectiveness of said feedback compensation.

46. A method as claimed in claim 45 comprising determining said effectiveness of said feedback compensation by checking a parameter of said adaptive feedback compensation filter.

47. A method as claimed in claim 45 comprising determining the effectiveness of said feedback compensation by comparing said feedback-compensated input signal to said output signal with regard to feedback content.

48. A method as claimed in claim 42 comprising determining the effectiveness of said feedback compensation by measuring said feedback in a frequency range.

49. A method as claimed in claim 36 wherein said input signal is subject to feedback via an acoustic feedback path.

50. A method as claimed in claim 36 wherein said input signal is subject to feedback via an electromagnetic feedback path.

51. A method as claimed in claim 36 comprising connecting an adaptation unit to said adaptive feedback compensation filter, evaluating a signal within said acoustic amplification system in said adaptation unit, and modifying operation of said adaptive feedback compensation filter dependent on the evaluation.

52. A method as claimed in claim 51 comprising supplying said input signal to said adaptation unit for error signal evaluation thereof.

53. A method as claimed in claim 52 comprising supplying said input signal to said adaptation unit through a further frequency-limiting filter.

54. A method as claimed in claim 53 comprising adapting a filter function of said further frequency-limiting filter during said feedback compensation by said adaptive feedback compensation filter.

55. A method as claimed in claim 54 comprising adapting the respective filter functions of said frequency-limiting filter and said further frequency-limiting filter with a control unit connected to said frequency-limiting filter and said further frequency-limiting filter.

56. A method as claimed in claim 55 comprising forming wherein said further feedback-limiting filter of a plurality of individual filters having respectively different filter functions that in combination form the filter function of said further frequency-limiting filter, and operating a changeover switch with said control unit to select at least one of said individual filters to adapt said filter function of said further frequency-limiting filter.

57. A method as claimed in claim 55 wherein said further frequency-limiting filter has filter coefficients, and comprising adjusting at least one of said filter coefficients with said control unit to adapt said filter function of said further frequency-limiting filter.

58. A method as claimed in claim 51 comprising supplying an output of said frequency-limiting filter to said adaptation unit.

59. A method as claimed in claim 58 comprising supplying said output of said frequency-limiting filter to said adaptation unit through a further frequency-limiting filter.

60. A method as claimed in claim 59 comprising adapting a filter function of wherein said further frequency-limiting filter during said feedback compensation by said adaptive feedback compensation filter.

61. A method as claimed in claim 60 comprising connecting a control unit to said frequency-limiting filter and said further frequency-limiting filter and adapting the respective filter functions of said frequency-limiting filter and said further frequency-limiting filter with said control unit.

62. A method as claimed in claim 61 comprising forming said further feedback-limiting filter of a plurality of individual filters having respectively different filter functions that in combination form the filter function of said further frequency-limiting filter, and operating a changeover switch with said control unit to select at least one of said individual filters to adapt said filter function of said further frequency-limiting filter.

63. A method as claimed in claim 61 wherein said further frequency-limiting filter has filter coefficients, and comprising adjusting at least one of said filter coefficients with said control unit to adapt said filter function of said further frequency-limiting filter.

64. A method as claimed in claim 51 wherein said frequency-limiting filter is a first frequency-limiting filter, and connecting said adaptation unit to receive said input signal and to receive an output from said first frequency-limiting filter, and supplying said input signal to said adaptation unit through a second frequency-limiting filter, and supplying said output from said first frequency-limiting filter to said adaptation unit through a third frequency-limiting filter.

65. A method as claimed in claim 64 comprising providing said second frequency-limiting filter with a filter function that is substantially identical to a filter function of said third frequency-limiting filter.

66. A method as claimed in claim 64 comprising adapting respective filter functions of said second and third frequency-limiting filters during said feedback compensation by said adaptive feedback compensation filter.

67. A method as claimed in claim 61 comprising connecting a control unit to said first, second and third frequency-limiting filters and adapting the respective filter functions of said first, second and third frequency-limiting filters with said control unit.

68. A method as claimed in claim 67 comprising forming each of said second and third frequency-limiting filters of a plurality of individual filters having respectively different filter functions that in combination form the respective filter functions of said first, second and third frequency-limiting filters, and operating a first changeover switch with said control unit to select at least one of said individual filters of said second frequency-limiting filter to adapt the filter function of said second frequency-limiting filter, and operating a second changeover switch with said control unit to select at least one of the individual filters of said third frequency-limiting filter to adapt the filter function of the third frequency-limiting filter.

69. A method as claimed in claim 67 wherein each of said second and third frequency-limiting filters has filter coefficients, and comprising adjusting at least one of the filter coefficients of said second frequency-limiting filter with said control unit to adapt the filter function of the second frequency-limiting filter, and adjusting at least one of the filter coefficients of the third frequency-limiting filter with said control unit to adapt the filter function of the third frequency-limiting filter.
